(19) United States
(12) Patent Application Publication
(10) Pub. No.: US 2023/0025185 A1
(43) Pub. Date: Jan. 26, 2023

(54) MODULAR, COLLAPSIBLE FOOD PREPARATION ASSEMBLY

(71) Applicants: Avraham RAHAMIM, Jerusalem (IL); Revital WINTER, Mitzpe Netofa, Galil Tachton (IL)

(72) Inventor: Revital WINTER, Mitzpe Netofa, Galil Tachton (IL)

(21) Appl. No.: 17/782,714

(22) PCT Filed: Nov. 26, 2020
(86) PCT No.: PCT/IB2020/061193

§ 371 Date: Jun. 6, 2022

Related U.S. Application Data
(60) Provisional application No. 62/943,857, filed on Dec. 5, 2019.

(51) Int. Cl. A47J 37/07; F24C 3/14

(52) U.S. Cl. CPC A47J 37/0763; F24C 3/14

(57) ABSTRACT

A culinary assembly configured for a variety of outdoor food preparation including at least frying, barbecuing, cooking, baking without leaving a mess. The base has attached wings configured to rotate upward from an open position in which the wings extend from the base outward to an enclosure position in which the wings form a lower portion of a housing. The base includes a burner with apertures for burning gas, and supports food directly on the burner for grilling and supports a pan for frying and supports a cauldron on the burner for cooking when the wings are in the enclosure position. A central portion of the housing is removably attachable to the lower portion and is made of separable modular parts. The central portion increase a height of the housing and intensifies the heat of the utensil. An upper portion forming a cover is removable attachable to the central portion.

### FIELD AND BACKGROUND

The invention is in the field of apparatuses used in food preparation, and in particular, an assembly such as a modular assembly, usable in multiple modes depending on the type of food preparation desired.

Many people in various countries go on frequent trips or vacations in nature. There are many types and forms of food preparation and cooking with fire. Cooking with a cauldron in particular or preparing food with fire in general requires a lot of technical effort and dirties you and the environment. Every family wants to go on a trip in nature in a private car, trailer or as part of a group outing, and to prepare stew or other food with fire. To do this, much work is required and it typically results in a mess and may well result in environmental damage such as burning of trees, use of coal, pollution etc. Yet fire remains the central and primary source of energy in food preparation.

### SUMMARY OF THE EMBODIMENTS

One embodiment is a culinary assembly configured to prepare a variety of foods outdoors without leaving a mess, the assembly comprising a base comprising a gas burner, the base for supporting a food or cooking utensil and having attached wings configured to rotate upward from an open position in which the wings extend from the base outward to an enclosure position in which the wings form a lower portion of a housing, a top portion of the housing comprising multiple sides and removably attachable to a top of the wings when the wings are in the enclosure position, the top portion configured to increase a height of the housing and further envelop the utensil, thereby intensifying a heating of the utensil, the top portion including a central portion, a leg portion attached to the base for resting the assembly on a surface.

In some embodiments, the wings are shaped such that in the open position distal ends of each of the wings are spaced apart from one another and in the enclosure position the distal ends are contiguous to one another.

In some embodiments, a number of the wings equals a number of the sides of the central portion.

In some embodiments, the central portion is comprised of polygonal sides.

In some embodiments, the central portion has six sides.

In some embodiments, the central portion is comprised of modular parts that are removably attachable to one another.

In some embodiments, the wings, in the extended position, are inclined upward from a surface on which the assembly rests at an angle of between 15 and 35 degrees.

In some embodiments, the top portion includes central portion and a cover to form an oven that envelops the utensil, thereby further intensifying the heating for baking, stewing and/or roasting. In some embodiments, the central portion and a cover are configured to be removably attached to one another. In some embodiments, the central portion is substantially perpendicular to the base and the upper and lower portions are each inclined, in opposite directions, from a wall of the central portion by substantially identical angles of rotation, wherein substantially identical means within 10% of one another.

In some embodiments, when the wings are configured to rotate to a maximum angle to the base of between approximately 30 degrees and approximately 70 degrees.

In some embodiments, the leg portion comprises multiple collapsible legs.

In some embodiments, the burner has apertures for facilitation of burning of gas and further comprising a gas inlet that projects from the burner and connects to a tube that connects to a gas balloon.

In some embodiments, the base includes a plate or grill over the burner.

Another embodiment is a culinary assembly configured to prepare a variety of foods outdoors without leaving a mess, the assembly comprising a base including a gas burner, for supporting a food or cooking utensil, wings attached to the base and configured to rotate upward from an open position in which the wings extend outward to an enclosure position in which the wings form a lower portion of a housing, wherein the wings are shaped such that in the open position distal ends of each of the wings are spaced apart from one another and in the enclosure position the distal ends are contiguous to one another, a top portion of the housing removably attachable to a top of the wings in the enclosure position of the wings to further envelop the utensil thereby intensifying a heating of the utensil, the top portion including at least a central portion, wherein a number of the wings equals a number of sides of the central portion.

In some embodiments, the top portion also includes a cover to form an oven that envelops the utensil, thereby further intensifying the heating for at least one of baking, roasting and stewing. In some embodiments, the central portion and cover are removably attachable to one another.

In some embodiments, wherein the central portion is made of multiple modular parts that are removably attachable to one another.

In some embodiments, the central portion is comprised of a number of sides that are of equal shape.

In some embodiments, each side of the central portion is a polygon.

In some embodiments, the central portion is comprised of six sides of equal shape.

In some embodiments, the number of sides of the central portion equals a number of sides of the upper portion.

In some embodiments, the assembly further comprises a leg portion attached to the base for resting the assembly on a surface.

In some embodiments, the wings are configured to rotate more than 30 degrees.

A still further embodiment is an assembly for food preparation convertible from a stove to an oven and vice versa, comprising a stove comprising a gas burner for direct barbecuing or supporting a frying pan, a pot or a cauldron, a perimeter of the burner having attached wings configured to rotate from an open position in which the wings extend outward from the burner to an enclosure position in which the wings rotate upward to form a lower portion of a housing, a central portion of the housing comprising multiple modular parts removably attachable to one another, the central portion configured to be removably attached to and rest on top of the wings in the enclosure position, the central portion configured to increase a height of the housing and further envelop the utensil, thereby intensifying a heating of any food in the pot or cauldron, wherein with the wings in the open position the assembly is configured for frying, for barbecuing and for grilling and with the wings in the enclosure position with or without the central portion the assembly is configured for cooking.

In some embodiments, the central portion is configured, together with the wings in the enclosure position, to envelope more than half a height of the cauldron.

In some embodiments, the wings, in the extended position, are inclined upward from a surface on which the assembly rests at an angle of between 15 and 35 degrees.

In some embodiments, in the open position the wings support a cooking utensil used in frying.

In some embodiments, the central portion is comprised of several sections that are removably attachable to one another.

A yet still further embodiment is a method of using a versatile apparatus for a range of food preparation without coals, comprising using an assembly comprising a base having a burner and wings attached to the base, the wings configured to rotate from an open position in which the wings extend outward from the base to an enclosure position in which the wings form a lower portion of a housing of the assembly, including: frying a first food in a pan on the burner with the wings in the open position, cooking a second food in a cauldron or pot on the burner with the wings in the enclosure position so as to envelope a lower portion of the cauldron or pot, baking a third food in an oven formed from the housing after a central portion is attached to the lower portion and after a cover is situated on the central portion.

A still further embodiment is a method of using a versatile apparatus for a range of food preparation, comprising using an assembly comprising a base having a burner and wings attached to the base and the wings configured to rotate from an open position in which the wings extend the base outwardly to an enclosure position in which the wings form a lower portion of a housing of the assembly, including: cooking in a cauldron or pot on the burner with the wings in the enclosure position so as to envelope a lower portion of the cauldron or pot, cooking with intensified heat after a central portion is attached to a top of the lower portion, baking food in an oven formed by the housing after a cover is attached to a top of the central portion.

These and other features, aspects and advantages will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a front view of a full culinary assembly with the central and top portions not attached to the lower portion of the housing, in accordance with one embodiment;

FIG. 2 is a perspective view from the front of a full culinary assembly with a top of the cover visible, in accordance with one embodiment;

FIG. 3 is a front view of a full culinary assembly fully assembled, in accordance with one embodiment;

FIG. 4 is a perspective view from the bottom of a full culinary assembly, in accordance with one embodiment;

FIG. 5 is a perspective view from the bottom of a full culinary assembly with a bottom of the base exposed, in accordance with one embodiment;

FIG. 6 is a perspective view from the top and side of the base and wings of culinary assembly in an open position with the burner exposed, in accordance with one embodiment;

FIG. 7 is a perspective view from the top and side of the base and wings of culinary assembly in an open position with a grill on the burner, in accordance with one embodiment;

FIG. 8 is a perspective view from the top and side of the base and wings of culinary assembly with a plate on the burner, in accordance with one embodiment;

FIG. 9 is a front view of a cauldron supportable by a burner of the assembly in accordance with one embodiment;

FIG. 10 is a flow chart showing a method in accordance with one embodiment; and

FIG. 11 is a flow chart showing a method in accordance with one embodiment.

### DETAILED DESCRIPTION OF THE EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

Generally, in certain embodiments, one can prepare stew and cook with a cauldron without trees, without coal and without any mess or environmental pollution. Any family in their yard or on their trip in nature can start preparing a great high quality meal within a few minutes with certain embodiments of the assembly. The assembly in certain embodiments provides slow cooking with intense heat around the pot or brief cooking on the fire or a variety of other food preparations. In some embodiments, the assembly is a modular and fodable product that can easily be carried anywhere in nature. The assembly in some embodiments includes several modular parts that can be quickly and easily assembled and has folding legs. It operates with a small gas balloon and can also be connected to gas balloons of different sizes. The assembly comes in a number of sizes including a small size suitable for preparing food for one person only and a large size for large pots and a lot of people to serve. The assembly is simple and convenient to prepare cauldron dishes on each trip (or frying or baking or other types of food preparation) without dirtying the vehicle or ruining the deck of your yacht (if that is how you choose to use it). In some embodiments, the assembly is adaptable to a full range of cooking methods.

Certain embodiments described herein generally provide a culinary assembly configured to prepare a variety of foods outdoors without leaving a mess. It is environmentally friendly and does not require coals. The assembly is conveniently storable in a trunk or a car. The assembly is typically modular. The assembly has a base that may include a gas burner and in some embodiments a grill or plate that sits on the burner. The base supports a food or cooking utensil such as a cauldron, pot, pan or any other desired or suitable cooking utensil.

The base has attached wings configured to rotate upward from an open position in which the wings extend from the base outward to an enclosure position in which the wings form a closed lower portion of a housing. The housing also includes a top portion, which may be a central portion or a central portion plus a cover. In some embodiments, the central portion and cover are removably attachable to one another but in either case the central portion and hence the top portion is removable attachable to the lower portion of the housing. The central portion comprises multiple sides and attaches to the top of the wings when the wings are in the enclosure position. This increases the height of the housing and further envelops the utensil with the food in it, thereby intensifying a heating of the utensil and food. A leg portion attached to the base is collapsible and may be configured for resting the assembly on a surface.

When the wings are spread outward in the open position, one can put a frying pan on the burner (or on a plate on the burner) or one can place food directly on the burner or optionally in some embodiments on a grill for barbecuing or grilling or on a plate such as a metal plate. When the wings are rotated upward to form the lower portion of the housing, a cauldron or pot may be placed on the base for cooking. The heat may be further intensified by adding all or part of a top portion on the wings, including a central portion of the housing or both a central portion and a cover. The central portion and cover are removably attachable to one another or are integrally formed depending on the embodiment. When the cover is included in the top portion, the assembly is most suitable for baking, stewing or roasting.

As used in this patent application the phrase “top portion” (i.e. of the housing) means either the central portion alone in cases where there is no cover situated on the central portion, or top portion means the central portion plus the cover, where there is a cover. The central portion and cover can be removable attachable to one another or in other embodiments they are joined together and in either case the central portion (which may be the top portion of part of the top portion) is removable attachable to the lower portion. Another name for the cover is “upper portion”. In some embodiments, the central portion itself is made of a number of modular parts and in some embodiments the cover itself is made of a number of modular parts. The lower portion is the enclosure formed by the wings after the wings have been rotated upward from the base to form contiguous sides. In one implementation, the burner is configured to attach via an inlet to a gas balloon.

The principles and operation of a Modular, Collapsible Food Preparation Assembly may be better understood with reference to the drawings and the accompanying description.

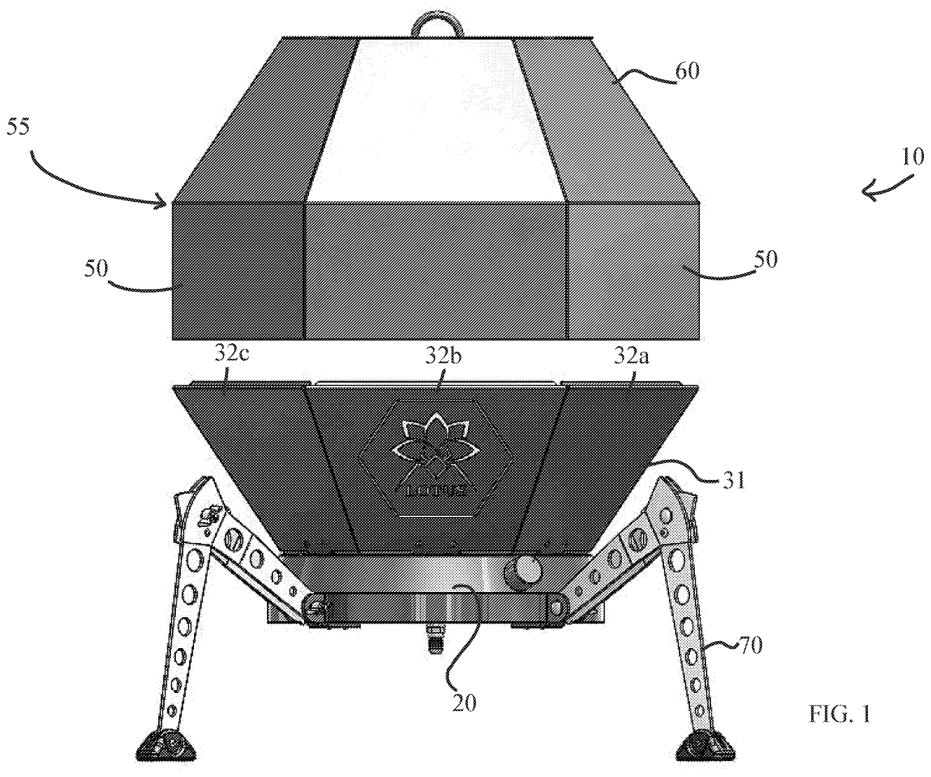

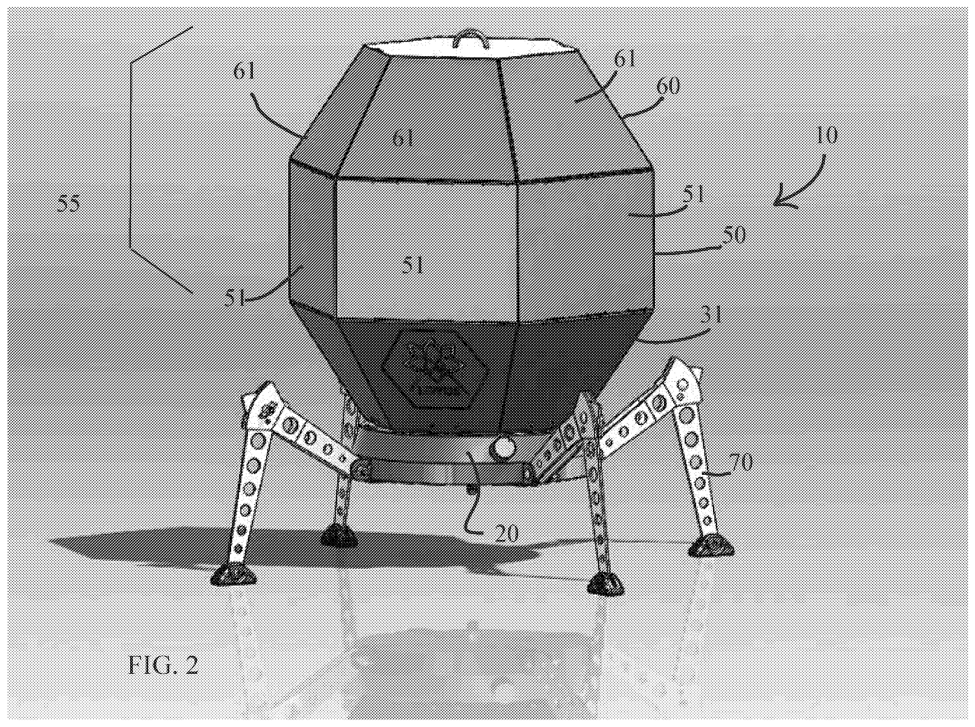

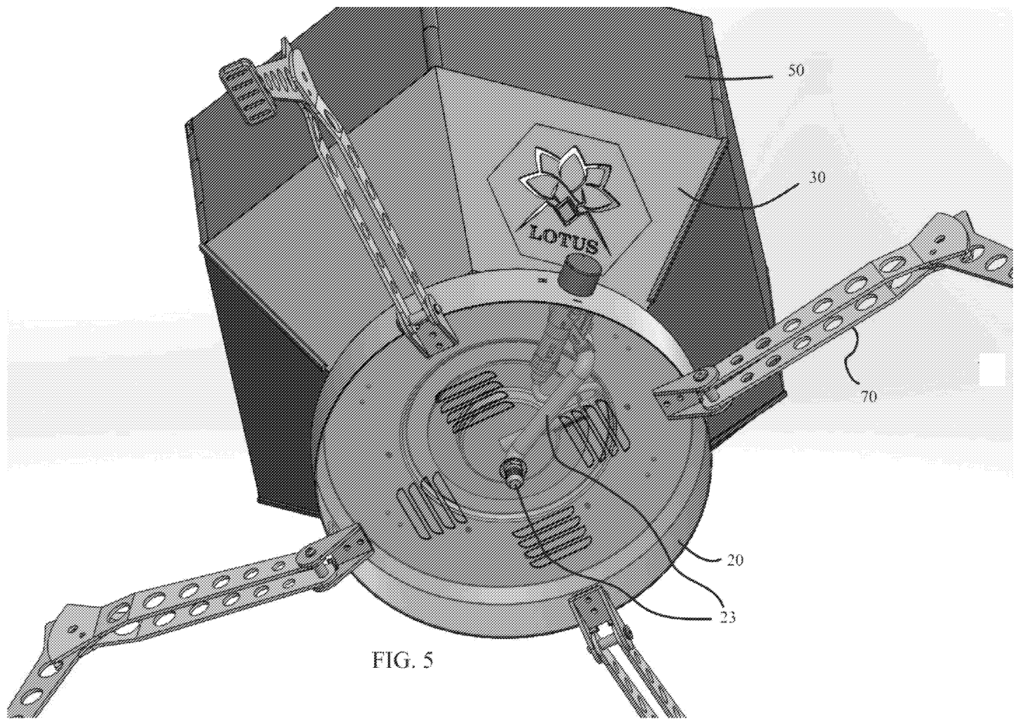

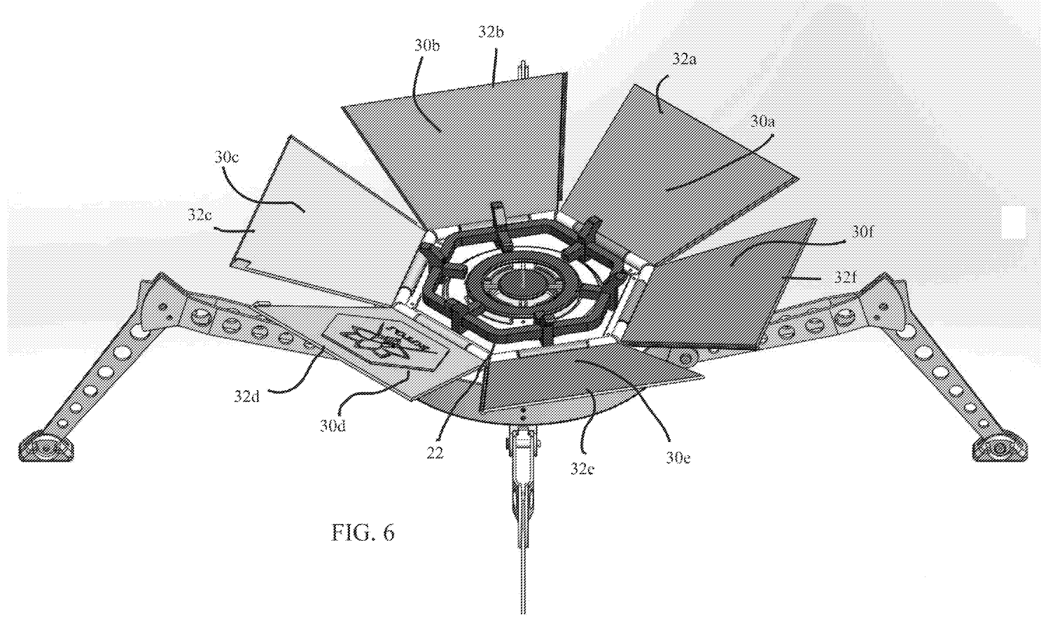

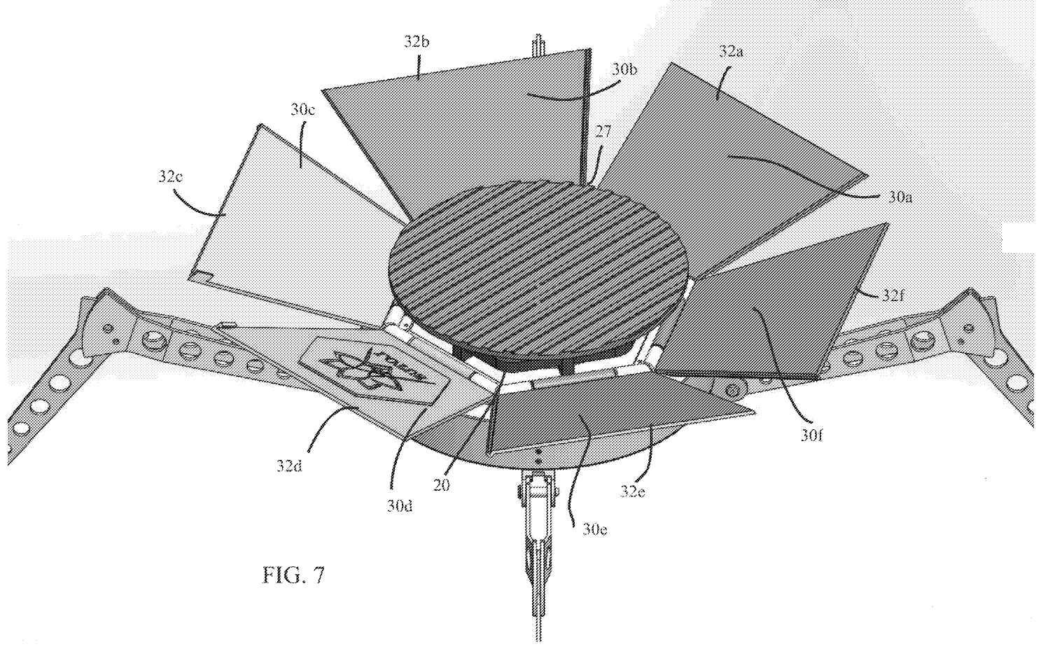

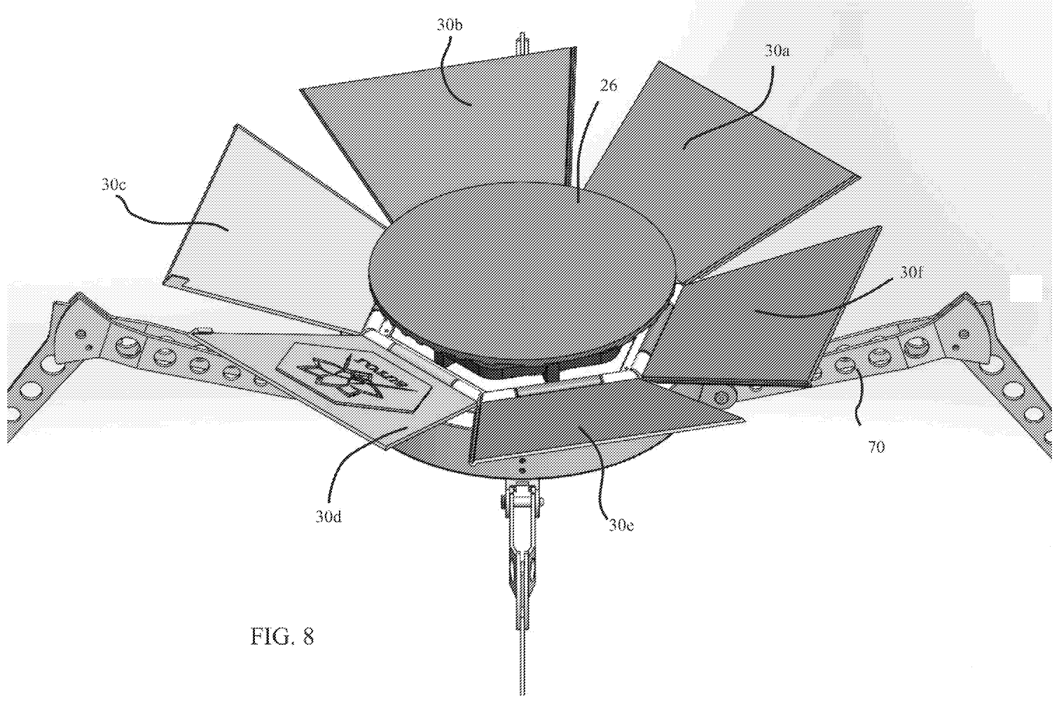

As seen from FIG. 1-3, one embodiment is a culinary assembly 10 configured to prepare a variety of foods outdoors without leaving a mess. Assembly 10 may include a base 20 comprising a burner, for example a gas burner 22 (FIG. 6). In some embodiments of assembly 10, although this is not required, one can place a grill (FIG. 7) or a plate (FIG. 8) over the burner 22 to support a pot or food or the burner 22 itself can support a pot or food. Base 20 is configured for supporting a food or cooking utensil. Base 20 has attached wings 30 configured to rotate upward from an open position (FIGS. 5-6 show wings 30 in an open position) in which the wings 30 extend from the base 20 outward to an enclosure position of wings 30 as shown in FIG. 1 in which wings 30 (have been rotated upward to) form a lower portion 31 of a housing 15 of assembly 10. The lower portion 31 is the enclosure formed by the wings 30 after wings 30 have been rotated upward from base 20 to form contiguous sides, as shown in FIG. 1 and FIG. 2 for example.

Housing 15 may also include a top portion 40 of the housing 15 or of the assembly 10. Top portion 40, which may have multiple sides, and is removably attachable to a top of wings 30 when the wings 30 are in the enclosure position shown in FIG. 1. Top portion 40 is configured to increase the height of the housing that further envelops the utensil holding the food being cooked, thereby intensifying the heating of the utensil and food.

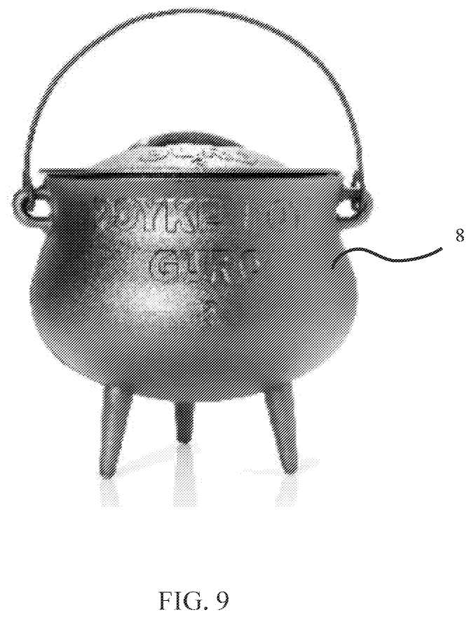

Assembly 10 may include a cover 60 configured to allow housing 15 to form an oven that envelops the cooking utensil 8 (FIG. 9), such as a cauldron or pot, that may be sitting on the burner 22, thereby further intensifying the heating for baking, stewing and/or roasting.

Accordingly, the phrase “top portion” 40 (of housing 15) refers to whatever part of housing 15 is above lower portion 31 of housing 15. In other words, top portion 40 refers to either just central portion 50 alone—in cases where there is no cover 60 situated on central portion 50, or in other cases top portion 40 refers to the combination of central portion 50 plus cover 60, in case there is a cover 60 on central portion 50. Central portion 50 and cover 60 are each closed portions of housing 15 when assembly 10 is operational for food preparation.

In some embodiments, central portion 50 and cover 60 are removable attachable from one another and in other embodiments they are joined together as a single unit when the user gets assembly 10 and cannot be separated. Another name for the cover is “upper portion”.

In some embodiments, the central portion 50 itself is made of a number of modular sections that are removably attachable to one another and in some embodiments the cover 60 itself is made of a number of modular sections that are removable attachable to one another. Each section of cover 60 may for example include three sides 61 or two sides 61.

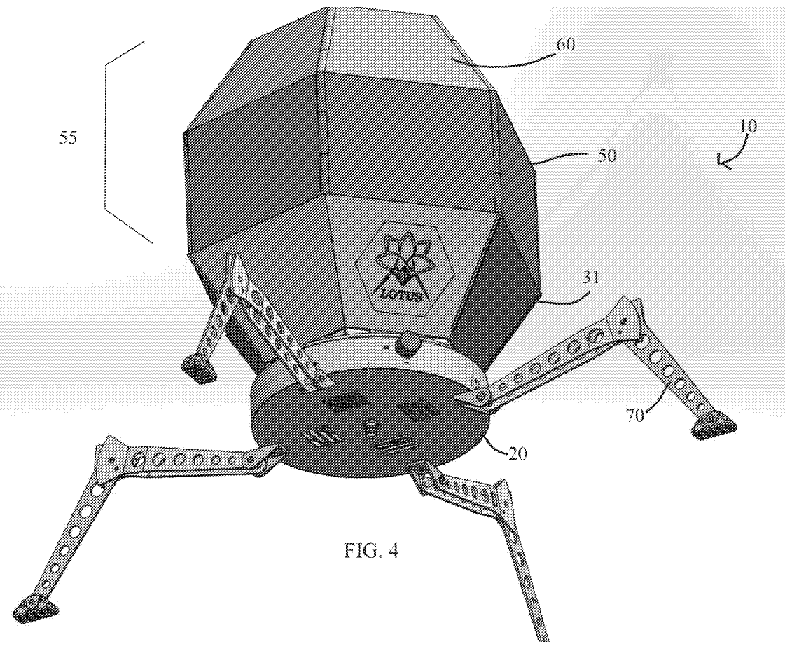

As seen from FIG. 1 through FIG. 6, assembly 10 may also include a leg portion 70 attached to base 20 for resting the assembly 10 on a surface. Leg portion 70 is shown in these figures to comprise four legs 70.

The specifics of the structure of assembly 10 in certain embodiments will now be discussed in greater detail.

It can be discerned from FIGS. 1-4 and FIGS. 6-8 that in some embodiments wings 30 are shaped such that in the open position distal ends 32 of each of the wings (for example wings 30a, 30b, 30c, 30d, 30e, 30f) are spaced apart from one another whereas after wings 30 have been rotated upward in the enclosure position to form lower portion 31, the distal ends 32 (for example 32a, 32b, 32c, 32d, 32e, 32f) are contiguous to one another. This is keep the heat generated from burner 22 from escaping the housing 15 of assembly 10 during a food preparation process such as cooking. Actually, FIGS. 6-8 depict wings 30 in a position where they have rotated slightly upward from the open position. In the open position, one may place a frying pan on the burner 22 or one may place meat or another food directly on the burner 22 or on a grill or plate on burner 22.

In some embodiments, the central portion 50 is configured, together with the wings 30 in the enclosure position, in other words the central portion together with the lower portion 31 but without the cover 70, to envelope more than half a height of the cauldron or pot sitting on base 20.

The number of the wings 30 may vary, though the drawings show an embodiment in which there are six wings 30. In the open position of wings 30 which can be appreciated from FIGS. 6-8 (although FIGS. 6-8 do not show wings 30 to be 180 degrees open (i.e. flat and on the same plane as each other) they show wings 30 in their maximum open and extended position in certain embodiments), wings 30 are somewhat inclined to the surface assembly 10 rests on and to burner 22 or may be inclined upward from a flat surface (parallel to the ground) on which the assembly 10 rests, for example at an angle of between about 10 degrees and about 30 degrees from such a surface, or at an angle of between about 15 degrees and about 30 or 35 degrees from the base. Typically, as seen from FIGS. 6-8, in the open position, wings are about 20 degrees to about 30 degrees inclined from a flat surface of the burner 22 or from a flat surface (parallel to the ground) on which assembly 10 rests. However, this can vary and is not a requirement. Generally, wings 30 are situated in the open and extended position for the purpose of being able to comfortably place a pan on burner 22.

Wings 30 may be rotated (from a maximum open position) upward as much as is necessary to form lower portion 31 of housing 15. In certain embodiments, this rotation involves a rotation of more than thirty degrees from the open position to the enclosure position of wings 30 in which wings 30 form lower portion 31 of housing 15. In certain implementations, in the enclosure position, wings 30 are configured to rotate to their maximum angle to the base 20 or burner 22 (or to the surface on which assembly 10 rests) of between approximately 30 degrees and approximately 70 or 75 degrees to the base or to the surface on which assembly 10 rests, for example 45 degrees or 50 degrees, or 55 degrees or 60 degrees or 65 degrees or 70 degrees.

In some embodiments, as seen in FIGS. 6-8, wings 30 are shaped such that in the open position distal ends of each of wings 30 are spaced apart from one another and in the enclosure position these distal ends are contiguous to one another. As shown in FIGS. 6-8, in some embodiments each of wings 30 is substantially trapezoidal with the longer side being the outer or distal edge or side of wings 30 and the shorter side being the point or line at which wings 30 meet the base 20 (and in some embodiments the line at which the wings 30 pivot from).

As noted, top portion 55, may include at least central portion 50 or central portion 50 and cover 60. FIGS. 1-4 depict a top portion 55 in which central portion 50 and cover 60 are integrally connected and the user does not need to combine them. In other embodiments, the user would first attach central portion 50 on top of wings 30 and then attach cover 60 on central portion 50.

In some embodiments, the number of wings 30 in central portion 50 corresponds to and equals the number of sides 51 of central portion 50, which is six in the embodiments shown in the drawings, although this number can vary.

In some embodiments, as shown in FIGS. 1-3, central portion 50 has a wall that is more or less perpendicular to burner 22. In some embodiments, moreover, central portion 50 is comprised of polygonal sides, for example six polygonal sides.

In some embodiments, the central portion 50, taken alone, is itself formed from multiple pieces, for example two or three modular pieces that are separable from one another (i.e. removably attachable to one another). If central portion 50 is comprised of three modular pieces, then each such modular piece may comprise two of the six sides of the central portion 50 (in embodiments in which there are six sides).

As seen from FIGS. 1-3, in some embodiments, central portion 50 is substantially perpendicular to base 20 while cover 60 (upper portion 60) and lower portion 30 are each inclined, in opposite directions, from a wall of the central portion 50 by substantially identical angles of rotation, wherein substantially identical means within 10% of one another.

In some embodiments, each side of central portion 50 is a polygon. Central portion 50 may be comprised of six sides of equal shape. The number of sides of the central portion 50 may equal the number of sides 61 of cover 60 or upper portion 60.

When top portion 55 includes both central portion 50 and also a cover 60 then an oven is formed by housing 15 that envelops the utensil on the burner, thereby further intensifying the heating for baking, stewing and/or roasting.

In some embodiments, the central portion 50 and cover 60 are configured to be removably attached to one another.

Assembly 10 may include a leg portion 70 comprised of several legs, for example four legs 70 and each of the legs 70 is foldable or collapsible so as to set or determine a height of base 20 of assembly 10 above the surface that assembly 10 rests on. The legs 70 are also configured to be situated radially outward from the base (not including wings 30). Legs 70 do not block any connection or inlet between burner 22 and a gas balloon. The gas balloon may be situated distant from assembly 10 depending on the length of the connecting inlet.

As best seen from FIG. 6, burner 22 may have apertures 25 to facilitate burning of gas and further comprising a gas inlet 23 (FIG. 5) and a small or large gas balloon (not shown) wherein the gas inlet 23 projects from burner 22 and connects in some implementations to a tube (not shown) that connects to the gas balloon (not shown).

As shown in FIGS. 6-8, burner 22 may be uncovered (FIG. 6) or may be covered with a plate 26 (FIG. 8) or a grill 27 (FIG. 7) as an additional way of grilling besides grilling on burner 22.

In one embodiment, a culinary assembly 10 is configured to prepare a variety of foods outdoors without leaving a mess, the assembly comprising a base including a burner, for example a gas burner 22, for supporting a food or cooking utensil, wings 30 attached to the base 20 and configured to rotate upward from an open position in which the wings extend outward to an enclosure position in which the wings 30 form a lower portion of a housing 15, wherein the wings are shaped such that in the open position distal ends of each of the wings 30 are spaced apart from one another and in the enclosure position the distal ends are contiguous to one another, a top portion 55 of the housing removably attachable to a top of the wings 30 in the enclosure position of the wings 30 to further envelop the utensil thereby intensifying a heating of the utensil, the top portion including at least a central portion. The number of the wings 30 may equal the number of sides of the central portion. The top portion 55 may also include a cover 70 to form an oven that envelops the utensil, thereby further intensifying the heating for at least one of baking, roasting and stewing.

The central portion 50 and cover 60 may be removably attachable to one another or in other embodiments are joined together and added together on top of lower portion 31. In some embodiments, central portion 50 is made of multiple modular parts that are removably attachable to one another (you can separate one from the other and put them back together). The central portion 50 may be comprised of a number of sides that are of equal shape. For example, each side of the central portion 50 may be a polygon and each of the wings 30 may be substantially trapezoidal. The central portion 50 may be comprised of six sides of equal shape in one particular implementation. In addition, in some embodiments, as seen from FIGS. 1-4, the number of sides of the central portion 50 may equal the number of wings 30 and may also equal the number of sides of the cover 60. The assembly 10 may have a leg portion 70 attached to the base 20 comprising foldable legs 70 for resting the assembly on a surface at different heights.

In any embodiment, the central portion may attach to the lower portion 31 by a friction fit or another stable form of attachment or any other known means of attachment. For example, each side of central portion 50 may mate with each top edge of wings 30. For example, one of them may have a male protrusion and the other a female cavity or vice versa. In some embodiments, the same mating relationship may exist between central portion and cover 70, or there may be a different stable attachment mechanism.

In one particular embodiment, there is an assembly 10 for food preparation convertible from a stove to an oven and vice versa, comprising a stove comprising a gas burner 22 for direct barbecuing or supporting a frying pan, a pot or a cauldron, a perimeter of the burner 22 having attached wings configured to rotate from an open position in which the wings extend outward from the burner to an enclosure position in which the wings 30 rotate upward to form a lower portion of a housing, a central portion 50 of the housing comprising multiple modular parts removably attachable to one another, the central portion 50 configured to be removably attached to and rest on top of the wings in the enclosure position, the central portion 50 configured to increase a height of the housing and further envelop the utensil, thereby intensifying a heating of any food in the pot 8 or cauldron 8, wherein with the wings 30 in the open position the assembly 10 is configured for frying, for barbecuing and for grilling and with the wings in the enclosure position with or without the central portion 50 the assembly is configured for cooking. For frying, the wings 30 would be put into or left in the open position so that a cooking utensil used in frying such as a pan (not shown) can be placed on the burner.

In some embodiments, central portion 50 is configured, together with the wings 30 in the enclosure position, in other words together with the lower portion 31, to envelope more than half a height of the cauldron or pot sitting on base 20. Wings 30, in the open position (sometimes called the extended position) may be inclined upward from a substantially flat surface on which the assembly 10 rests at an angle of between 15 and 35 degrees.

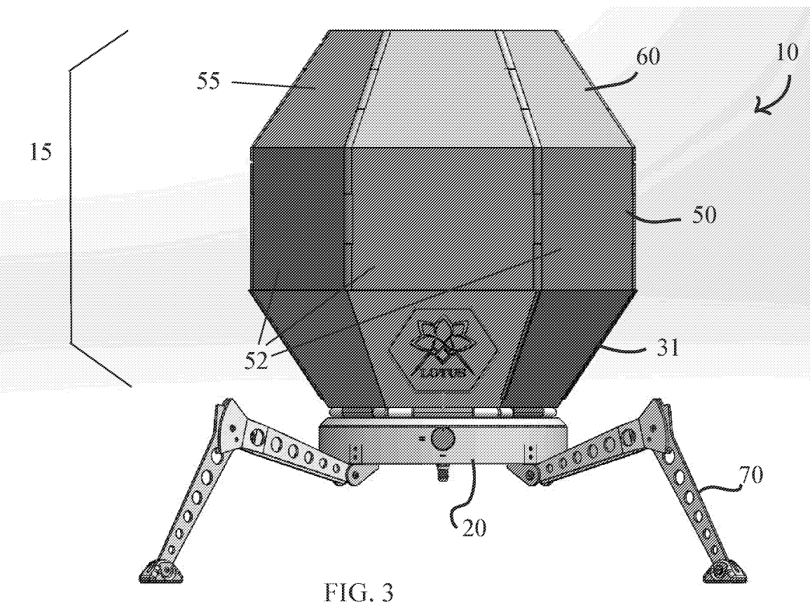

In any embodiment, central portion 50 may be comprised of several separable (removable attachable) sections, for example 2 sections or three sections. For example, one such section 52 (FIG. 3) may be comprised of three sides 51 or of two sides 51.

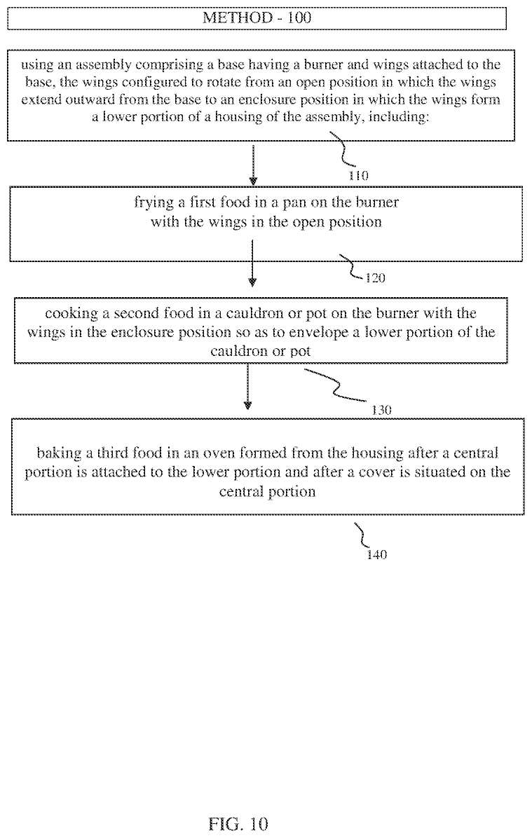

FIG. 10 is a flow chart that describes a method 100 of using a versatile culinary apparatus for a range of food preparation without coals. Method 100 may comprise a step 110 of using an assembly comprising a base having a burner and wings attached to the base, the wings configured to rotate from an open position in which the wings extend outward from the base to an enclosure position in which the wings form a lower portion of a housing of the assembly, including by a substep 120 of frying a first food in a pan on the burner with the wings in the open position, a substep 130 of cooking a second food in a cauldron or pot on the burner with the wings in the enclosure position so as to envelope a lower portion of the cauldron or pot, and a substep 130 of baking a third food in an oven formed from the housing after a central portion is attached to the lower portion and after a cover is situated on the central portion.

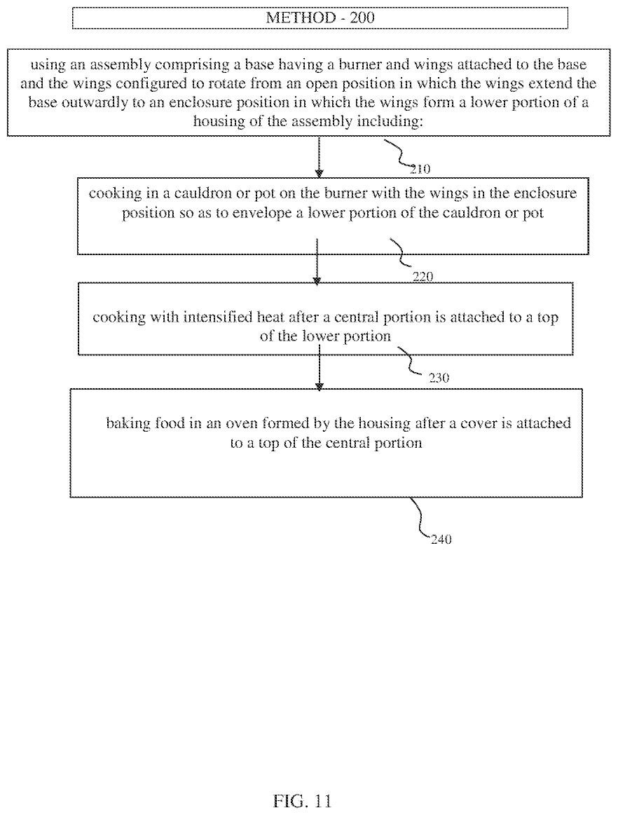

FIG. 11 is a flow chart showing a method of using a versatile apparatus for a range of food preparation. Method 200 may comprise a step 210 of using an assembly comprising a base having a burner and wings attached to the base and the wings configured to rotate from an open position in which the wings extend the base outwardly to an enclosure position in which the wings form a lower portion of a housing of the assembly, including a substep 220 of cooking in a cauldron or pot on the burner with the wings in the enclosure position so as to envelope a lower portion of the cauldron or pot, a substep 230 of cooking with intensified heat after a central portion is attached to a top of the wings forming the lower portion, and a substep 240 of baking food in an oven formed by the housing after a cover is attached to a top of the central portion.

In all of the embodiments shown herein, each of wings 30 are substantially flat, although in certain other versions of these embodiments, wings 30 can be curved as long as in the enclosure position wings combine to create a closed lower portion 31 of housing 15.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A culinary assembly configured to prepare a variety of foods outdoors without leaving a mess, the assembly comprising:
a base comprising a gas burner, the base for supporting a food or cooking utensil and having attached wings configured to rotate upward from an open position in which the wings extend from the base outward to an enclosure position in which the wings form a lower portion of a housing,
a top portion of the housing comprising multiple sides and removably attachable to a top of the wings when the wings are in the enclosure position, the top portion configured to increase a height of the housing.

2. The assembly of claim 1, wherein the wings are shaped such that in the open position distal ends of each of the wings are spaced apart from one another and in the enclosure position the distal ends are contiguous to one another.

3. The assembly of claim 1, wherein a number of the wings equals a number of the sides of the central portion.

4. The assembly of claim 1, wherein the central portion is comprised of polygonal sides.

5. (canceled)

6. The assembly of claim 1, wherein the central portion is comprised of modular parts that are removably attachable to one another.

7. The assembly of claim 1, wherein the wings, in the extended position, are inclined upward from a surface on which the assembly rests at an angle of between 15 and 35 degrees.

8. The assembly of claim 1, wherein the top portion includes a central portion and a cover to form an oven that envelops the utensil, thereby further intensifying the heating for baking, stewing and/or roasting.

9. The assembly of claim 8, wherein the central portion and the cover are configured to be removably attached to one another.

10. The assembly of claim 9, wherein the central portion is substantially perpendicular to the base and the wings and sides of the cover are each inclined, in opposite directions, from a wall of the central portion by substantially identical angles of rotation, wherein substantially identical means within 10% of one another.

11. (canceled)

12. The assembly of claim 23 wherein the leg portion comprises multiple collapsible legs.

13. The assembly of claim 1, wherein the burner has apertures for facilitation of burning of gas and further comprising a gas inlet that projects from the burner and connects to a tube that connects to a gas balloon.

14. The assembly of claim 1, wherein the base includes a plate or grill over the burner.

15-20. (canceled)

21. The assembly of claim 1, wherein the central portion is comprised of six sides of equal shape.

22. (canceled)

23. The assembly of claim 1, further comprising a leg portion attached to the base for resting the assembly on a surface.

24. The assembly of claim 1, wherein the wings are configured to rotate more than 30 degrees.

25. An assembly for food preparation convertible from a stove to an oven and vice versa, comprising:
a stove comprising a gas burner for direct barbecuing or supporting a frying pan, a pot or a cauldron, a perimeter of the burner having attached wings configured to rotate from an open position in which the wings extend outward from the burner to an enclosure position in which the wings rotate upward to form a lower portion of a housing,
a central portion of the housing comprising multiple modular parts removably attachable to one another, the central portion configured to be removably attached to and rest on top of the wings in the enclosure position, the central portion configured to increase a height of the housing and further envelop the utensil, thereby intensifying a heating of any food in the pot or cauldron,
wherein with the wings in the open position the assembly is configured for frying, for barbecuing and for grilling and with the wings in the enclosure position with or without the central portion the assembly is configured for cooking.

26. The assembly of claim 25, wherein the central portion is configured, together with the wings in the enclosure position, to envelope more than half a height of the cauldron.

27. (canceled)

28. The assembly of claim 25, wherein in the open position the wings support a cooking utensil used in frying.

29-30. (canceled)

31. A method of using a versatile apparatus for a range of food preparation, comprising:
using an assembly comprising a base having a burner and wings attached to the base and the wings configured to rotate from an open position in which the wings extend the base outwardly to an enclosure position in which the wings form a lower portion of a housing of the assembly, including:
cooking in a cauldron or pot on the burner with the wings in the enclosure position so as to envelope a lower portion of the cauldron or pot,
cooking with intensified heat after a central portion is attached to a top of the lower portion,
baking food in an oven formed by the housing after a cover is attached to a top of the central portion.
